(19) United States
(12) Patent Application Publication
(10) Pub. No.: US 2026/0035157 A1
(43) Pub. Date: Feb. 5, 2026

(54) DROPPER BOTTLE PROTECTION ASSEMBLY AND DROPPER PROTECTION STRUCTURE

(71) Applicant: Quintin Haag, Deforest, WI (US)

(72) Inventor: Quintin Haag, Deforest, WI (US)

(21) Appl. No.: 18/789,101

(22) Filed: Jul. 30, 2024

(51) Int. Cl. B65D 81/113; B65D 47/18

(52) U.S. Cl. CPC B65D 81/113; B65D 47/18

(57) ABSTRACT

A dropper protection structure to protect a dropper of a dropper bottle, which dropper protection structure includes a shock-absorbing material to protect a dropper cap of a dropper and a pipette connected to the dropper cap against breakage from impact forces and compression forces, a top portion designed to cover a lower portion of a dropper bulb, and a side portion designed to cover a side surface of a dropper cap.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to dropper bottles and more particularly pertains to a new dropper bottle protection assembly for protecting both the bottle and the dropper from damage from impact forces and compression forces. Dropper bottles are small containers for holding different liquids, such as for cooking or for use for health and beauty reasons, which commonly include a glass bottle and a dropper for sucking up an amount of liquid and then dispensing drops thereof. The dropper is made of a dropper cap, usually a plastic threaded screw cap, a dropper bulb, usually rubber and partially seated in an opening in the dropper cap, and a pipette, usually glass and partially inserted in the dropper bulb. The dropper bottle is relatively fragile as the glass bottle can be easily broken. The plastic cap can also be cracked. Finally, the pipette can be damaged even though it is located mostly inside the bottle. To further explain, the upper end of the pipette, which usually has a lip to retain the upper end of the pipette inside the dropper bulb, projects out beyond the bottle and the dropper cap, and thus is only protected by the dropper bulb, which is rather thin and quite flexible and compressible. Consequently, compression or impact against the dropper bulb can result in compression or impact against the upper portion of the pipette, which can result in breakage of the upper portion and possibly further fracturing along the body of the pipette. Breakage of any of these components can result in leakage of the liquid contents, as well as possibly malfunctioning of the dropper, which is obviously undesirable. The dropper bottle protection assembly protects against such damage. The dropper protection structure protects the dropper cap and the pipette.

### (2) Description of Related Art Including Information Disclosed Under 37 CFR 1.97 and 1.98

The prior art relates to baby bottles, water bottles, and vials that have sleeves that fully or partially cover the body of the bottle for protection or gripping purposes, but do not relate to dropper bottles. The prior art, as best understood, does not disclose a dropper protection structure to protect the dropper of a dropper bottle, which dropper includes a dropper cap, a dropper bulb, and a pipette. The dropper protection structure includes a shock-absorbing material to protect the dropper cap and the pipette against breakage from impact forces and compression forces, such as due to being accidentally dropped or crushed, and further includes a top portion designed to cover a lower portion of the dropper bulb and a side portion designed to cover a side surface of the dropper cap.

### BRIEF SUMMARY OF THE INVENTION

An embodiment of the disclosure meets the needs presented above in a dropper protection structure generally comprising a shock-absorbing material to protect a dropper cap of a dropper and a pipette connected to the dropper cap against breakage from impact forces and compression forces, a top portion designed to cover a lower portion of a dropper bulb, and a side portion designed to cover a side surface of a dropper cap.

Another embodiment of the disclosure meets the needs presented above in a dropper bottle protection assembly generally comprising a bottle protection structure and a dropper protection structure. The bottle protection structure includes a shock-absorbing material and is designed to cover and protect a bottle body against breakage from impact forces and compression forces. The dropper protection structure includes a shock-absorbing material and is designed to cover an outer surface of a dropper cap and a lower portion of a dropper bulb to protect the dropper cap and a pipette connected to the dropper cap against breakage from impact forces and compression forces.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a dropper bottle protection assembly according to an embodiment of the disclosure.

FIG. 2 is a bottom perspective view of an embodiment of the disclosure.

FIG. 3 is an exploded view of an embodiment of the disclosure in use.

FIG. 4 is an exploded view of an embodiment of the disclosure in use.

FIG. 5 is a perspective view of an embodiment of the disclosure in use.

FIG. 6 is a perspective view of a dropper bottle.

FIG. 7 is a perspective view of an embodiment of the disclosure in use.

FIG. 8 is a side view of an embodiment of the disclosure in use.

FIG. 9 is a side cross-sectional view of an embodiment of the disclosure in use.

FIG. 10 is a top perspective view of an alternative embodiment of the disclosure in use.

### DETAILED DESCRIPTION OF THE INVENTION

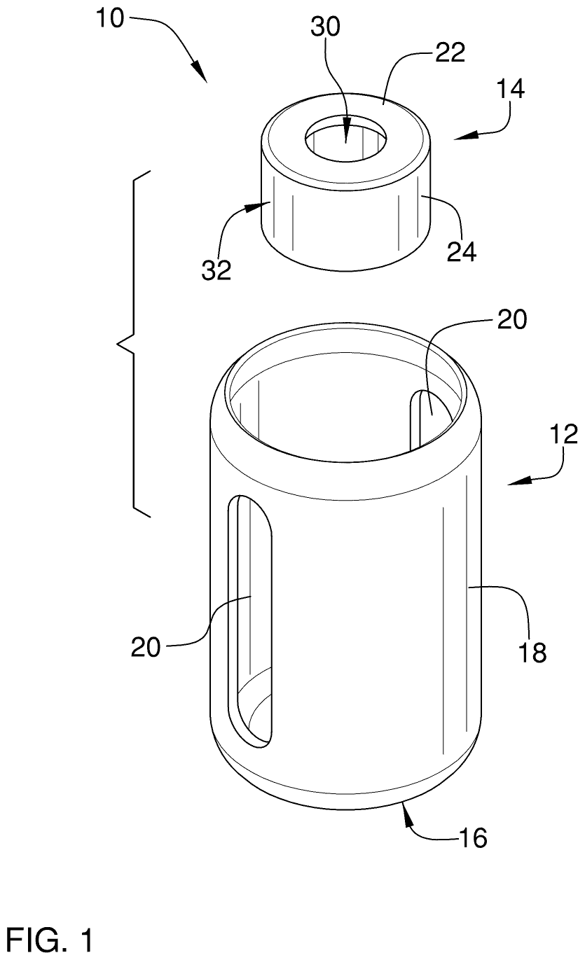

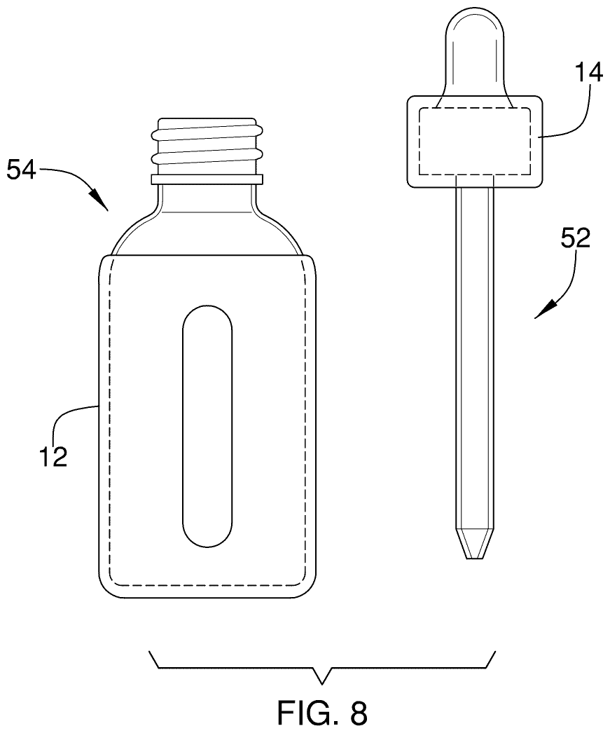

With reference now to the drawings, and in particular to FIGS. 1 through 10 thereof, a new dropper bottle protection assembly embodying the principles and concepts of an embodiment of the disclosure and generally designated by the reference numeral 10 will be described.

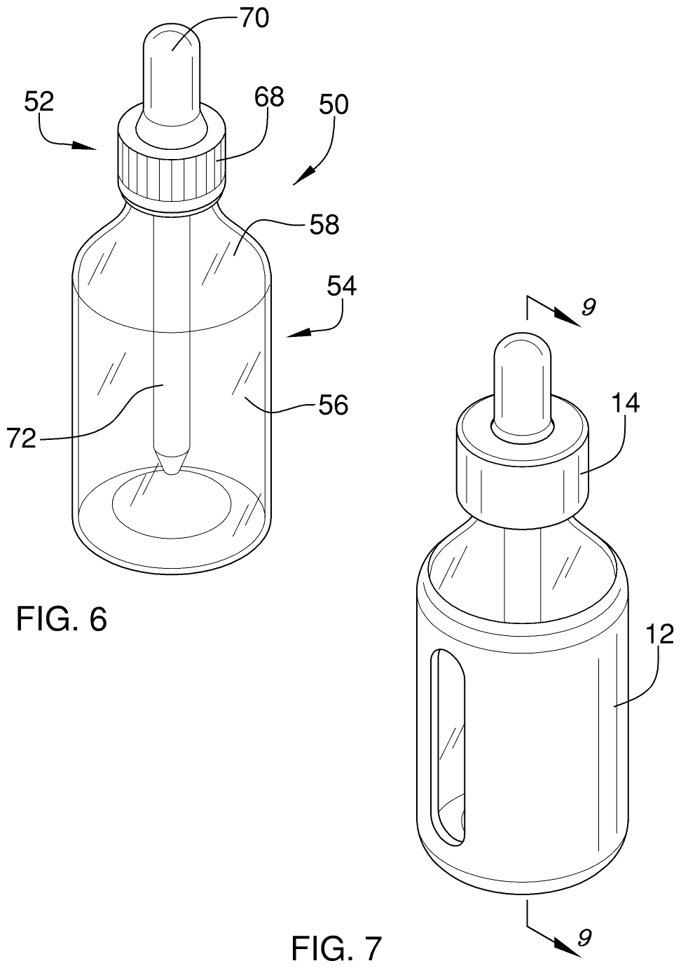

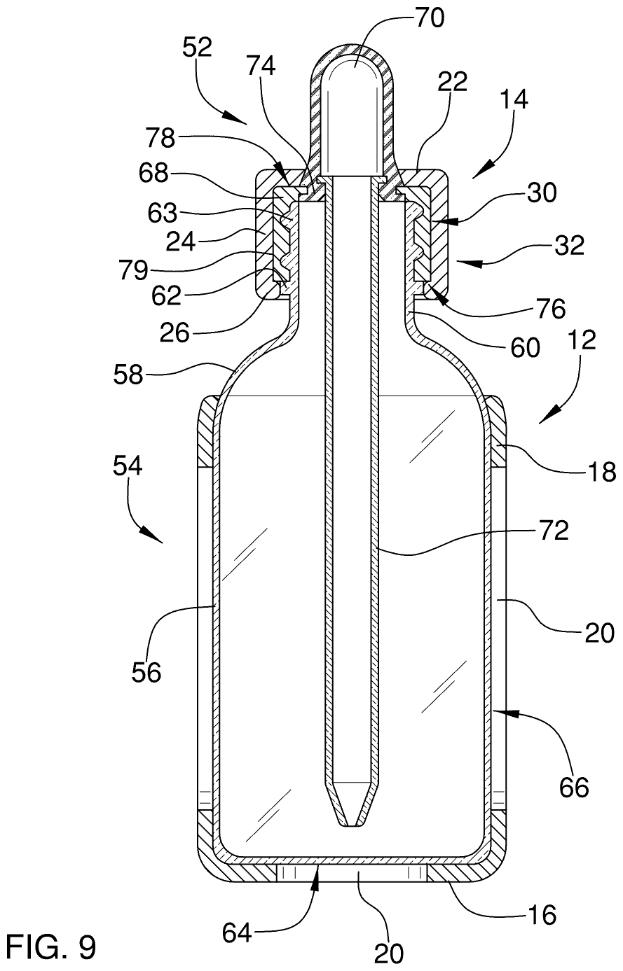

Before discussing the dropper bottle protection assembly 10, it should be noted that the dropper bottle protection assembly 10 is designed for use with a dropper bottle 50, such as shown in FIG. 6. The dropper bottle 50 shown has a design common to dropper bottles in the container arts, wherein the dropper bottle 50 is a combination of a dropper 52 and a bottle 54. As best seen in FIG. 9, the bottle 54 includes a bottle body 56, a curved shoulder portion 58, a neck portion 60 with an annular ring 62, and a threaded mouth portion 63. The bottle body 56 includes a bottom surface 64 and a cylindrical side surface 66. Such dropper bottles are often quite small, wherein the bottle body 56 has a diameter of about 2 to 5 centimeters and the overall height of the dropper bottle 50 is about 7 to 15 centimeters. Such dropper bottles are designed to hold volumes of liquid in the range of about 5 to 100 milliliters. As best seen in FIG. 9, the dropper 52 includes a dropper cap 68, a dropper bulb 70 connected to and inserted through an opening in the dropper cap 68, and a pipette 72 connected to and partially inserted into the dropper bulb 70. Usually, the bottle 54 is made of glass, the dropper cap 68 is plastic, the dropper bulb 70 is rubber or similar elastomer, and the pipette 72 is made of glass, though other materials are within the scope of the disclosure and well known in the container arts.

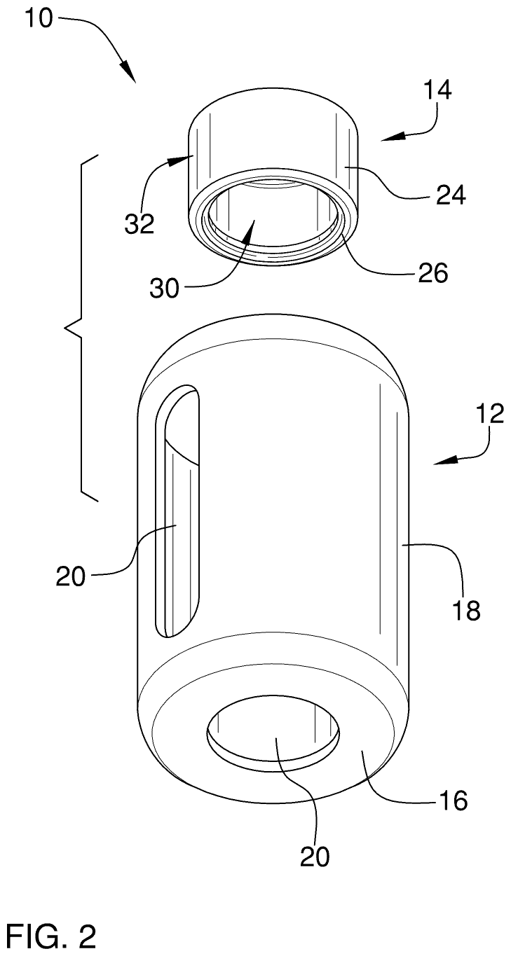

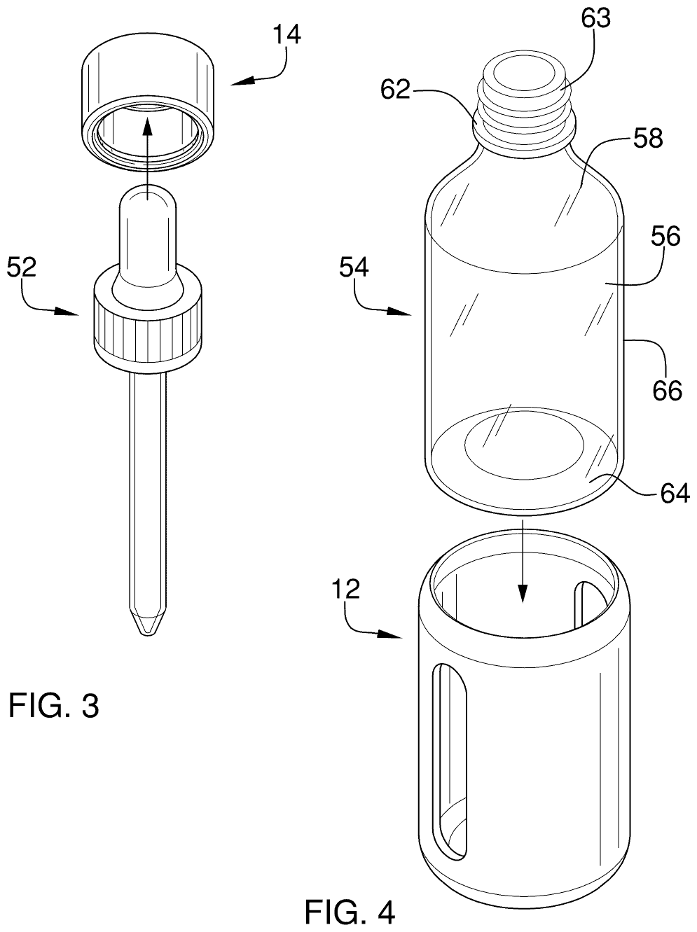

FIGS. 1 and 2 show an exemplary embodiment of a dropper protection structure 14, which generally includes a shock-absorbing material to protect the dropper cap 68 of the dropper 52 and the pipette 72 connected to the dropper cap 68 against breakage from impact forces and compression forces. The dropper protection structure 14 includes a top portion 22 designed to cover a top surface 78 of the dropper cap 68 and surround and cover a lower portion 74 of the dropper bulb 70. The dropper protection structure 14 further includes a side portion 24 extending from and transverse to the top portion 22 and designed to cover a cylindrical side surface 79 of the dropper cap 68. It should be noted that FIGS. 1, 2, and 5 through 10 show the dropper protection structure 14 in conjunction with a bottle protection structure 12 to form the dropper bottle protection assembly 10. However, in one possible embodiment the dropper bottle protection assembly 10 could omit the bottle protection structure 12, such that only the dropper protection structure 14 is included, or vice versa. For example, FIG. 3 shows only the dropper protection structure 14 being installed, and FIG. 4 shows only the bottle protection structure 12 being installed.

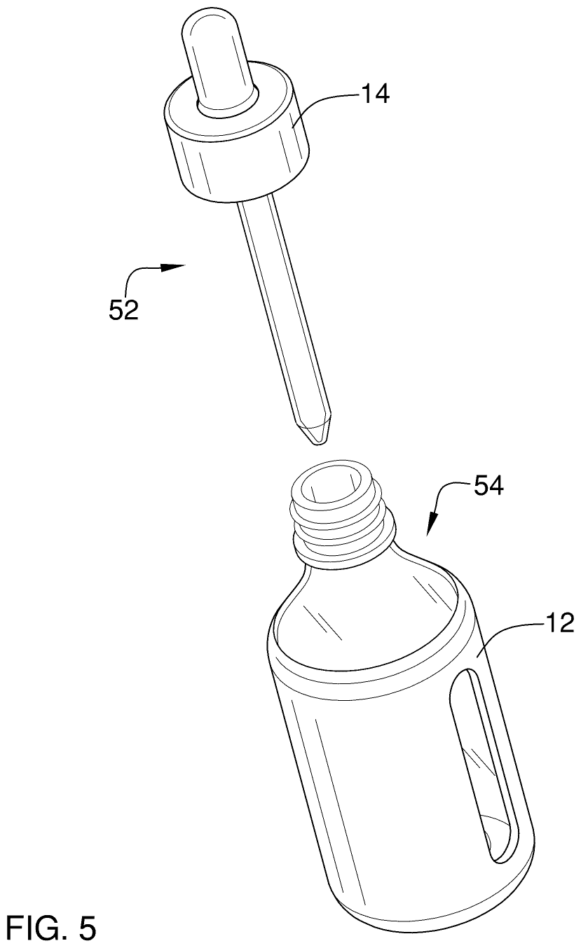

The bottle protection structure 12 includes a shock-absorbing material and is designed to cover and protect the bottle body 56 of the dropper bottle 50 against breakage from impact forces and compression forces. FIG. 3 shows the dropper protection structure 14 being installed on the dropper 52 of the dropper bottle 50. FIG. 4 shows the bottle protection structure 12 being installed on the bottle body 56 of the bottle 54. FIGS. 5 and 7 through 10 show the dropper bottle protection assembly 10 installed on the dropper bottle 50.

In the exemplary embodiment shown in FIGS. 1 and 2, the bottle protection structure 12 is in the form of a sleeve designed to fit onto and around an outer surface of the bottle body 56, as shown in FIGS. 3 and 9. Similarly, the dropper protection structure 14 is in the form of a sleeve designed to fit onto and around an outer surface of the dropper cap 68 and a lower portion 74 of the dropper bulb 70, as shown in FIGS. 4 and 9. In another possible embodiment, the bottle protection structure 12 could be a different shape, such as bands, strips, or rings. In the exemplary embodiment, the shock-absorbing material for both the bottle protection structure 12 and the dropper protection structure 14 is flexible and resilient. The degree of flexibility and resiliency can be varied as desired in the manufacturing process. The thickness of the shock-absorbing material can also be varied. The shock-absorbing material could be an elastomer, such as rubber or silicone or viscoelastic plastic.

With reference to FIG. 9, the bottle protection structure 12 includes a bottom section 16 designed to cover the bottom surface 64 of the bottle body 56 and a side section 18 extending from and transverse to the bottom section 16 and designed to cover the cylindrical side surface 66 of the bottle body 56. The side section 18 is sufficiently long to cover the cylindrical side surface 66 of the bottle body 56 from the bottom surface 64 of the bottle body 56 to the curved shoulder portion 58 of the bottle body 56. In the exemplary embodiment shown in FIG. 9, this side section 18 is sufficiently long to additionally cover a portion of the curved shoulder portion 58 of the bottle body 56. The side section 18 has a slight curvature, due to design shape, the resiliency of the shock-absorbing material, or both, that assists in retaining the bottle protection structure 12 on the bottle body 56.

As shown in FIG. 1, the bottle protection structure 12 can include an orifice 20 in the side section 18, or two or more orifices 20. As shown in FIG. 2, the bottle protection structure 12 can include an orifice 20 in the bottom section 16. The orifices 20 can be used to allow a user to view a label on the outer surface of the bottle body 56, the amount of liquid in the bottle body 56, and the type of liquid in the bottle body 56, as well as provide gripping areas for a hand and fingers of the user.

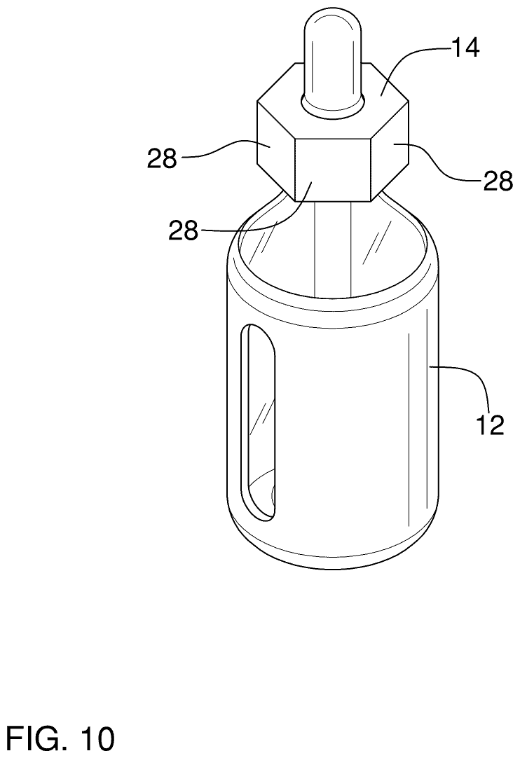

With reference to FIG. 9, the dropper protection structure 14 is in the form of a sleeve designed to fit onto and around an outer surface of the dropper cap 68 and a lower portion 74 of the dropper bulb 70. In the exemplary embodiment shown, the dropper protection structure 14 also includes a bottom portion 26 designed to project beyond and inwardly under a bottom edge 76 of the dropper cap 68 to cover and protect the bottom edge 76 of the dropper cap 68 and the annular ring 62 of the neck portion 60 against breakage, though in one possible embodiment the bottom portion 26 could be omitted. Since the dropper cap 68 is cylindrical, the side portion 24 includes an inner surface 30 that is cylindrical, however an outer surface 32 of the dropper cap 68 can be essentially any shape. In the exemplary embodiment in FIGS. 1 through 9, the outer surface 32 of the dropper cap 68 is cylindrical. However, in another possible embodiment, the outer surface 32 can include a plurality of polygonal sections 28 such that the dropper protection structure 14 has a polygonal prism shape. FIG. 10 shows an example, wherein the outer surface 32 includes six polygonal sections 28 such that the dropper protection structure 14 has a hexagonal prism shape. Other polygonal prism shapes are within the scope of the disclosure, such as triangular, square, or rectangular. The polygonal prism shapes could be designed to increase the shock absorbing characteristics of the dropper protection structure 14, as well as provide enhanced gripping for users to more easily open the dropper bottle 50.

In one possible embodiment, the dropper protection structure 14 is permanently attached to or integrally formed as part of the dropper cap 68 to form a modified dropper cap 68. Alternatively or in addition, the bottle protection structure 12 is permanently attached to the bottle body 56 to form a modified bottle 54.

In use, the bottle protection structure 12 protects the bottle body 56 from breakage due to impact forces or compression forces, such as from drops or being squeezed or pressed between objects. The dropper protection structure 14 protects the dropper cap 68 and the pipette 72, as well as the mouth portion 63 of the bottle 54, from breakage due to impact forces or compression forces.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A dropper protection structure to protect a dropper of a dropper bottle comprising:
a shock-absorbing material to protect a dropper cap of a dropper and a pipette connected to the dropper cap against breakage from impact forces and compression forces;
a top portion configured to cover a lower portion of a dropper bulb; and
a side portion configured to cover a side surface of a dropper cap.

2. The dropper bottle protection structure of claim 1, wherein said dropper protection structure is in the form of a sleeve configured to fit onto and around an outer surface of a dropper cap and a lower portion of a dropper bulb.

3. The dropper bottle protection structure of claim 2, wherein said top portion is configured to cover a top surface of a dropper cap and surround and cover a lower portion of a dropper bulb, and said side portion extends transversely from said top portion and is configured to cover a cylindrical side surface of the dropper cap.

4. The dropper bottle protection structure of claim 3, wherein said dropper protection structure further comprises a bottom portion configured to project beyond and inwardly under a bottom edge of a dropper cap to cover and protect the bottom edge of the dropper cap and an annular ring of a bottle neck against breakage.

5. The dropper bottle protection structure of claim 1, wherein said dropper protection structure further comprises a bottom portion configured to project beyond and inwardly under a bottom edge of a dropper cap to cover and protect the bottom edge of the dropper cap and an annular ring of a bottle neck against breakage.

6. The dropper bottle protection structure of claim 4, wherein said side portion comprises an inner surface being cylindrical and an outer surface.

7. The dropper bottle protection structure of claim 6, wherein said outer surface is cylindrical.

8. The dropper bottle protection structure of claim 6, wherein said outer surface comprises a plurality of polygonal sections such that said dropper protection structure has a polygonal prism shape.

9. The dropper bottle protection structure of claim 1, wherein said side portion comprises an outer surface that is cylindrical.

10. The dropper bottle protection structure of claim 1, wherein said side portion comprises an outer surface that comprises a plurality of polygonal sections such that said dropper protection structure has a polygonal prism shape.

11. The dropper bottle protection structure of claim 1, wherein said shock-absorbing material is flexible and resilient.

12. The dropper bottle protection structure of claim 1, in combination with a dropper of a dropper bottle comprising a dropper cap, a dropper bulb, and a pipette, wherein said dropper protection structure is permanently attached to or integrally formed as part of said dropper cap.

13. A dropper bottle protection assembly comprising:
a bottle protection structure comprising a shock-absorbing material and being configured to cover and protect a bottle body against breakage from impact forces and compression forces; and
a dropper protection structure comprising a shock-absorbing material and being configured to cover an outer surface of a dropper cap and a lower portion of a dropper bulb to protect the dropper cap and a pipette connected to the dropper cap against breakage from impact forces and compression forces.

14. The dropper bottle protection assembly of claim 13, wherein said dropper protection structure is in the form of a sleeve and comprises a top portion configured to cover a top surface of a dropper cap and surround and cover a lower portion of a dropper bulb and a side portion extending transversely from said top portion and configured to cover a cylindrical side surface of the dropper cap.

15. The dropper bottle protection assembly of claim 14, wherein said dropper protection structure further comprises a bottom portion configured to project beyond and inwardly under a bottom edge of a dropper cap to cover and protect the bottom edge of the dropper cap and an annular ring of a bottle neck against breakage.

16. The dropper bottle protection structure of claim 15, wherein said side portion comprises an inner surface being cylindrical and an outer surface.

17. The dropper bottle protection structure of claim 16, wherein said outer surface is cylindrical.

18. The dropper bottle protection structure of claim 16, wherein said outer surface comprises a plurality of polygonal sections such that said dropper protection structure has a polygonal prism shape.

19. The dropper bottle protection assembly of claim 14, wherein said bottle protection structure is in the form of a sleeve configured to fit onto and around an outer surface of a bottle body and comprises a bottom section configured to cover a bottom surface of a bottle body and a side section extending from and transverse to said bottom section and configured to cover a cylindrical side surface of a bottle body.

20. The dropper bottle protection assembly of claim 19, wherein said bottle protection structure comprises an orifice in said side section and an orifice in said bottom section, and wherein said side section is sufficiently long to cover a cylindrical side surface of a bottle body from a bottom surface of the bottle body to a curved shoulder portion of the bottle body, and additionally cover a portion of a curved shoulder portion of a bottle body.
